(19) United States
(12) Patent Application Publication
(10) Pub. No.: US 2018/0270773 A1
(43) Pub. Date: Sep. 20, 2018

(54) OPERATION METHOD OF COMMUNICATION NODE IN COMMUNICATION NETWORK

(71) Applicant: ELECTRONICS AND TELECOMMUNICATIONS RESEARCH INSTITUTE, Daejeon (KR)

(72) Inventors: Seok Jin LEE, Daejeon (KR); Hoon LEE, Daejeon (KR)

(73) Assignee: ELECTRONICS AND TELECOMMUNICATIONS RESEARCH INSTITUTE, Daejeon (KR)

(21) Appl. No.: 15/923,728

(22) Filed: Mar. 16, 2018

(30) Foreign Application Priority Data
Mar. 16, 2017 (KR) 10-2017-0033175
Mar. 16, 2018 (KR) 10-2018-0030726

(51) Int. Cl. H04W 56/00; H04L 5/14

(52) U.S. Cl. CPC H04W 56/005; G01S 19/07; H04L 5/1469; H04W 56/0015

(57) ABSTRACT

Disclosed is an operation method of a communication node in a communication network. The operation method of the communication node having divided functions of a base station in a communication network may comprise generating digital pulse signals based on a high-speed clock synthesis for a time synchronization signal used for a synchronization operation of the communication node; performing counting on the digital pulse signals based on a notification setting value obtained in advance for controlling the synchronization operation of the communication node; generating a pulse signal corresponding to the notification configured value based on a result of the counting; and performing a function of the communication node, which is divided according to supporting functions of the base station, by performing an operation indicated by the generated pulse signal.

### CROSS-REFERENCE TO RELATED APPLICATIONS

This application claims priorities to Korean Patent Applications No. 10-2017-0033175 filed on Mar. 16, 2017 and No. 10-2018-0030726 filed on Mar. 16, 2018 in the Korean Intellectual Property Office (KIPO), the entire contents of which are hereby incorporated by reference.

### BACKGROUND

### 1. Technical Field

The present disclosure relates to an operation method of a communication node in a communication network, and more specifically, to an operation method of a communication node for performing divided functions of a base station in a communication network.

### 2. Related Art

The communication system includes a core network (e.g., a mobility management entity (MME), a serving gateway (SGW), a packet data network (PDW) gateway (PGW), and the like), at least one base station (e.g., a macro base station, a small base station, a relay, and the like), at least one terminal, and the like. The communications between the base station and the terminal may be performed using at least one of various radio access technologies (e.g., 4G communication technologies, 5G communication technologies, wireless local area network (WLAN) technologies, wireless personal area network (WPAN) technologies, etc.).

The base station may be connected to the core network via a wired backhaul or a wireless backhaul. For example, the base station may transmit data, control information, etc. received from the terminal to the core network through the wired backhaul or the wireless backhaul. The base station may also receive data, control information, etc. from the core network via the wired backhaul or the wireless backhaul.

In the communication network, a base station may be divided into a digital unit (DU) and a radio unit (RU) according to their functions. Alternatively, the base station may be divided into a cloud digital unit (CDU) and a remote radio head (RRH). The DU (or CDU) may be connected to the RU (or RRH) via a transport network (e.g., an Xhaul network (or a mobile Xhaul network (MXN), a fronthaul network, a backhaul network, etc.)). The transport network may include at least one Xhaul central unit (XCU) (or mXhaul), at least one hub, at least one terminal, etc. Here, each of the hub and the terminal may be connected to an Xhaul distributed unit (XDU).

Thus, the DU and RU (or CDU and RRH) divided according to their supporting functions among functions of a base station are using a time division duplex (TDD) scheme to transmit or receive frames. Such the TDD scheme may mean a scheme in which a plurality of subframes included in a frame are divided into at least one uplink (UL) frame or at least one downlink (DL) frame.

Accordingly, the DU and the RU need to temporally distinguish each of the plurality of subframes for accurate frame transmission. To this end, the DU and the RU are required to acquire time synchronization with each other accurately. However, if the distance between the DU and the RU becomes too far away, or the performance of the synchronization function decreases due to the functional deterioration of the DU and the RU, there may be a problem that a collision occurs between the frames transmitted between the DU and the RU.

### SUMMARY

Accordingly, embodiments of the present disclosure provide an operation method of a communication node for controlling synchronization of a radio unit (RU) in a communication network.

In order to achieve the objective of the present disclosure, an operation method of a communication node having divided functions of a base station in a communication network, the operation method may comprise generating digital pulse signals based on a high-speed clock synthesis for a time synchronization signal used for a synchronization operation of the communication node; performing counting on the digital pulse signals based on a notification setting value obtained in advance for controlling the synchronization operation of the communication node; generating a pulse signal corresponding to the notification configured value based on a result of the counting; and performing a function of the communication node, which is divided according to supporting functions of the base station, by performing an operation indicated by the generated pulse signal.

Here, the time synchronization signal may be an 1 Pulse-Per-Second (1PPS) signal based on a global positioning system (GPS) signal obtained through a GPS module.

Here, the communication node may be a radio unit (RU) of the base station, which transmits and receives radio signals through an RF antenna.

Here, the base station may support a time division duplexing (TDD) scheme.

Here, the base station may be a small base station supporting a small cell or a micro base station supporting a micro cell based on a millimeter-wave band.

Here, the notification setting value may be obtained in advance from a macro base station supporting a macro cell through a wireless communication module included in the communication node.

Here, in the generating a pulse signal, when a value of the counting reaches a first target value according to the notification setting value, a first time pulse signal according to the first target value may be generated.

Here, in the generating a pulse signal, when the value of the counting reaches a second target value according to the notification setting value, a second time pulse signal according to the second target value may be generated.

Here, the operation method may further comprise, when a value of the counting reaches a cycle of the 1PPS signal, initializing the value of the counting.

Here, the operation method may further comprise obtaining a control data value used for controlling a function performed in the communication node; and controlling the function performed in the communication node based on the obtained control data value.

Here, the control data value may be obtained in advance from a macro base station supporting a macro cell through a wireless communication module included in the communication node.

In order to achieve the objective of the present disclosure, a communication node having divided functions of a time division duplexing (TDD) scheme based base station in a communication network, the communication node may comprise a processor and a memory storing at least one instruction executed by the processor. Also, the at least one instruction may be configured to generate digital pulse signals based on a high-speed clock synthesis for a time synchronization signal used for a synchronization operation of the communication node; perform counting on the digital pulse signals based on a notification setting value obtained in advance for controlling the synchronization operation of the communication node; generate a pulse signal corresponding to the notification setting value based on a result of the counting; and perform a function of the communication node, which is divided according to supporting functions of the base station, by performing an operation indicated by the generated pulse signal.

Here, the time synchronization signal may be an 1 Pulse-Per-Second (1PPS) signal based on a global positioning system (GPS) signal obtained through a GPS module.

Here, the communication node may be a radio unit (RU) of the base station, which transmits and receives radio signals through an RF antenna.

Here, the notification setting value may be obtained in advance from a macro base station supporting a macro cell through a wireless communication module included in the communication node.

Here, the at least one instruction may be further configured to, when a value of the counting reaches a first target value according to the notification setting value, generate a first time pulse signal according to the first target value.

Here, the at least one instruction may be further configured to, when the value of the counting reaches a second target value according to the notification setting value, generate a second time pulse signal according to the second target value.

Here, the at least one instruction may be further configured to, when a value of the counting reaches a cycle of the 1PPS signal, initialize the value of the counting.

Here, the at least one instruction may be further configured to obtain a control data value used for controlling a function performed in the communication node; and control the function performed in the communication node based on the obtained control data value.

Here, the control data value may be obtained in advance from a macro base station supporting a macro cell through a wireless communication module included in the communication node.

Using the embodiments according to the present disclosure, synchronization of an RU can be accurately controlled, so that the TDD scheme can be applied more efficiently. Also, the RU can stably control the synchronization of a small base station supporting a small cell or a micro base station supporting a micro cell by receiving control information for controlling the synchronization o the RU from a macro base station.

### BRIEF DESCRIPTION OF DRAWINGS

Embodiments of the present disclosure will become more apparent by describing in detail embodiments of the present disclosure with reference to the accompanying drawings, in which:

FIG. 1 is a conceptual diagram illustrating a communication node divided according to its supporting function among functions of a base station in a communication network according to an embodiment of the present disclosure;

FIG. 2 is a block diagram illustrating a communication node performing an operation method of a communication node according to an embodiment of the present disclosure;

FIG. 3 is a conceptual diagram illustrating a radio frame of a communication node according to an embodiment of the present disclosure;

FIG. 4 is a block diagram illustrating an operation method of a communication node in a communication network according to an embodiment of the present disclosure;

FIG. 5 is a conceptual diagram illustrating a circuit used for frequency synthesis in a communication network according an embodiment of the present disclosure;

FIG. 6 is a flow chart illustrating a method of generating a pulse signal in a communication network according an embodiment of the present disclosure;

FIG. 7 is a block diagram illustrating an operation method of a communication node in a communication network according another embodiment of the present disclosure; and

FIG. 8 is a concept diagram illustrating an example to which a method of controlling and operating synchronization according to the present disclosure is applied.

### DETAILED DESCRIPTION

Embodiments of the present disclosure are disclosed herein. However, specific structural and functional details disclosed herein are merely representative for purposes of describing embodiments of the present disclosure, however, embodiments of the present disclosure may be embodied in many alternate forms and should not be construed as limited to embodiments of the present disclosure set forth herein.

Accordingly, while the present disclosure is susceptible to various modifications and alternative forms, specific embodiments thereof are shown by way of example in the drawings and will herein be described in detail. It should be understood, however, that there is no intent to limit the present disclosure to the particular forms disclosed, but on the contrary, the present disclosure is to cover all modifications, equivalents, and alternatives falling within the spirit and scope of the present disclosure. Like numbers refer to like elements throughout the description of the figures.

It will be understood that, although the terms first, second, etc. may be used herein to describe various elements, these elements should not be limited by these terms. These terms are only used to distinguish one element from another. For example, a first element could be termed a second element, and, similarly, a second element could be termed a first element, without departing from the scope of the present disclosure. As used herein, the term “and/or” includes any and all combinations of one or more of the associated listed items.

It will be understood that when an element is referred to as being “connected” or “coupled” to another element, it can be directly connected or coupled to the other element or intervening elements may be present. In contrast, when an element is referred to as being “directly connected” or “directly coupled” to another element, there are no intervening elements present. Other words used to describe the relationship between elements should be interpreted in a like fashion (i.e., “between” versus “directly between,” “adjacent” versus “directly adjacent,” etc.).

The terminology used herein is for the purpose of describing particular embodiments only and is not intended to be limiting of the present disclosure. As used herein, the singular forms “a,” “an” and “the” are intended to include the plural forms as well, unless the context clearly indicates otherwise. It will be further understood that the terms “comprises,” “comprising,” “includes” and/or “including,” when used herein, specify the presence of stated features, integers, steps, operations, elements, and/or components, but do not preclude the presence or addition of one or more other features, integers, steps, operations, elements, components, and/or groups thereof.

Unless otherwise defined, all terms (including technical and scientific terms) used herein have the same meaning as commonly understood by one of ordinary skill in the art to which this present disclosure belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

Hereinafter, embodiments of the present disclosure will be described in greater detail with reference to the accompanying drawings. In order to facilitate general understanding in describing the present disclosure, the same components in the drawings are denoted with the same reference signs, and repeated description thereof will be omitted.

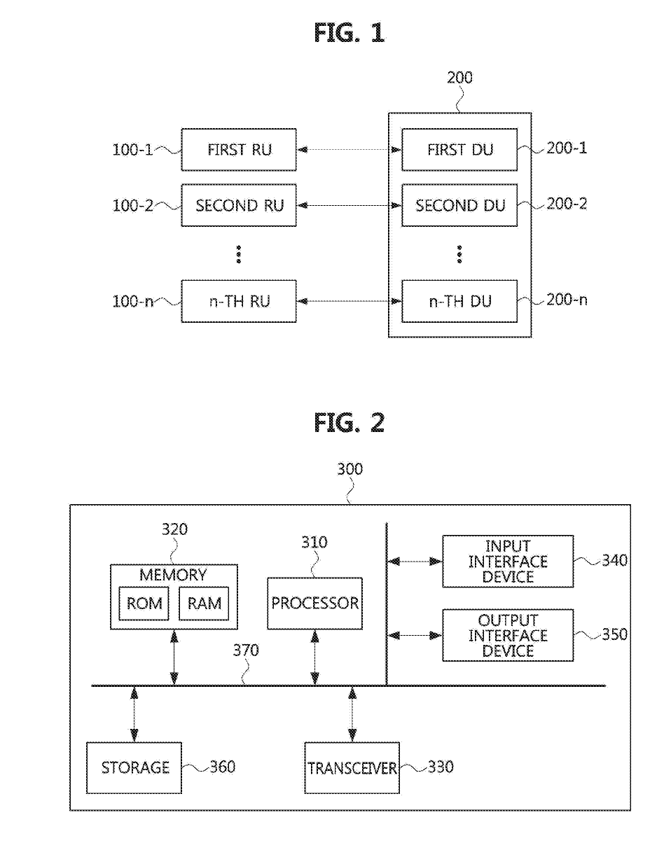

FIG. 1 is a conceptual diagram illustrating a communication node divided according to its supporting function among functions of a base station in a communication network according to an embodiment of the present disclosure.

Referring to FIG. 1, in a communication network according to an embodiment of the present disclosure, a base station may be divided into a plurality of sub-units according to a function that each of the plurality of sub-units supports. Specifically, in the communication network, a base station may be divided into a digital unit (DU) for processing data of the base station and a radio unit (RU) for transmitting and receiving a radio signal for the data. Also, the DU and RU of the base station in the communication network may be physically separated and installed.

At this time, a plurality of DUs of a plurality of base stations included in the communication network may be concentratedly installed at predetermined locations. Also, the RUs of the plurality of base stations may be installed as distributed.

For example, a first RU 100-1 of a first base station, a second RU 100-2 of a second base station, and an n-th RU 100-n of an n-th base station may be installed as distributed. Also, a first DU 200-1 of the first base station, a second DU 200-2 of the second base station, and an n-th DU 200-n of the n-th base station may be concentrated on a predetermined location 200.

The communications between the DUs and the RUs in the communication network may be performed based on a communication interface such as a common public radio interface (CPRI), an open base station architecture initiative (OBSAI), and an open radio interface (ORI).

A communication node performing an operation method according to an embodiment of the present disclosure may be a DU or an RU. Hereinafter, with reference to FIGS. 2 to 6, an operation method of a communication node according to an embodiment of the present disclosure will be described in detail.

FIG. 2 is a block diagram illustrating a communication node performing an operation method of a communication node according to an embodiment of the present disclosure.

Referring to FIG. 2, a communication node 300 performing an operation method according to an embodiment of the present disclosure may be an RU or a DU described with reference to FIG. 1.

Specifically, the communication node 300 may comprise at least one processor 310, a memory 320, and a transceiver 330 connected to a network for performing communications. Also, the communication node 300 may further comprise an input interface device 340, an output interface device 350, a storage device 360, and the like. Each component included in the communication node 300 may communicate with each other as connected through a bus 370.

The processor 310 may execute program commands stored in the memory 320 and/or the storage device 360. The processor 310 may refer to a central processing unit (CPU), a graphics processing unit (GPU), or a dedicated processor on which methods in accordance with embodiments of the present disclosure are performed. Each of the memory 320 and the storage device 360 may be constituted by at least one of a volatile storage medium and a non-volatile storage medium. For example, the memory 320 may comprise at least one of read-only memory (ROM) and random access memory (RAM). Here, the program executed through the processor 310 may include a plurality of steps for performing an operation method of a communication node in a communication network proposed by the present disclosure.

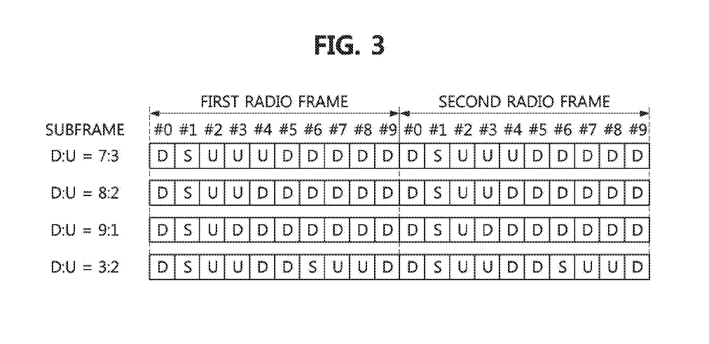

FIG. 3 is a conceptual diagram illustrating a radio frame of a communication node according to an embodiment of the present disclosure.

Referring to FIG. 3, a radio frame transmitted and received by the communication node performing an operation method according to an embodiment of the present disclosure may include 10 subframes. Specifically, a first radio frame may include 10 subframes (e.g., subframes #0 to #9). Also, a second radio frame may include 10 subframes (e.g., subframes #0 to #9).

For example, the length of the radio frame may be 2 ms, and the length of each of the plurality of subframes included in the radio frame may be 200 μs. Also, the radio frame may include at least one DL subframe, at least one UL subframe, and at least one special subframe. Also, the radio frame may include at least one DL subframe and at least one UL subframe according to a preset ratio.

Specifically, the ratio of the DL subframes (denoted by ‘D’ in FIG. 3) and the UL subframes (denoted by ‘U’ in FIG. 3) of the first radio frame according to a first embodiment may be ‘7:3’. In this case, the first radio frame may include subframe #0, subframe #1, and subframes #5 to subframe #9 as the DL subframes. Further, the first radio frame may include subframe #2, subframe #3, and subframe #4 as the UL frames. Here, the subframe #1 of the plurality of subframes included in the first radio frame may be a special subframe.

The special subframe may include a downlink pilot time slot (DwPTS), a guard period (GP), and an uplink pilot time slot (UpPTS). The DwPTS may be regarded as a downlink interval and may be used for UE cell search, time and frequency synchronization acquisition, and the like. Here, the length of the DwPTS may be longer than the length of the UpPTS. Accordingly, in FIG. 3, the special subframe may be regarded as a DL subframe. However, although it is assumed that the special subframe is regarded as a DL subframe in FIG. 3, but it may not necessarily be regarded as a DL subframe.

Also, the GP included in the special subframe may be used for solving an interference problem of UL data transmission caused by DL data reception delay. Also, the GP may include a time required for switching from a DL data reception operation to an UL data transmission operation. The UpPTS may be used for UL channel estimation, time and frequency synchronization acquisition, and the like.

As described above, the lengths of the DwPTS, the GP, and the UpPTS included in the special subframe may be variably adjusted as needed. Also, the number and position of each of the DL subframe, the UL subframe, and the special subframe included in the radio frame may be changed as needed.

In addition, the second radio frame according to the first embodiment may include DL subframes and UL subframes according to a ratio equal to the ratio of the DL subframes and the UL subframes of the first radio frame. Here, among the plurality of subframes included in the second radio frame, the subframe #1 may be a special subframe and may be regarded as a downlink subframe.

Meanwhile, the ratio of the DL subframes and the UL subframes of the first radio frame according to a second embodiment may be ‘8:2’. In this case, the first radio frame may include subframe #0, subframe #1, and subframes #4 to #9 as the DL subframes. Also, the first radio frame may include subframe #2 and subframe #3 as the UL subframes. Here, among the plurality of subframes included in the first radio frame, the subframe #1 may be a special subframe and may be regarded as a DL subframe.

In addition, the second radio frame according to the second embodiment may include DL subframes and UL subframes according to a ratio equal to the ratio of the DL subframes and the UL subframes of the first radio frame. Here, among the plurality of subframes included in the second radio frame, the subframe #1 may be a special subframe and may be regarded as a DL subframe.

Meanwhile, the ratio of the DL subframes and the UL subframes of the first radio frame according to a third embodiment may be ‘9:1’. In this case, the first radio frame may include subframe #0, subframe #1, and subframes #3 to #9 as the DL subframes. Also, the first radio frame may include subframe #2 as a UL subframe. Here, among the plurality of subframes included in the first radio frame, the subframe #1 may be a special subframe and may be regarded as a DL subframe.

In addition, the second radio frame according to the third embodiment may include DL subframes and UL subframes according to a ratio equal to the ratio of the DL subframes and the UL subframes of the first radio frame. Here, among the plurality of subframes included in the second radio frame, the subframe #1 may be a special subframe and may be regarded as a DL subframe.

Meanwhile, the ratio of the DL subframes and the UL subframes of the first radio frame according to a fourth embodiment may be ‘3:2’. In this case, the first radio frame may include subframe #0, subframe #1, subframe #4, subframe #5, subframe #6, and subframe #9 as the DL subframes. Also, the first radio frame may include subframe #2, subframe #3, subframe #7, and subframe #8 as the UL subframes. Here, among the plurality of subframes included in the first radio frame, each of the subframe #1 and subframe #6 may be a special subframe.

In addition, the second radio frame according to the fourth embodiment may include DL subframes and UL subframes according to a ratio equal to the ratio of the DL subframes and the UL subframes of the first radio frame. Here, among the plurality of subframes included in the second radio frame, each of the subframe #1 and subframe #6 may be a special subframe.

As described above, the frame transmitted and received by the communication node performing the operation method according to the present disclosure may include DL subframes and UL subframes according to a preset ratio.

For this, according to an operation method of a communication node in a communication network according to an embodiment of the present disclosure, in order to use a subframe as an uplink subframe or a downlink subframe, a ‘notification setting value’ for a target time may be configured in advance. That is, the notification setting value may be configured in advance for the use purpose of the subframe (e.g., as one of the uplink subframe and the downlink subframe). Here, when a cycle in 1 second unit is newly started, the communication node may eliminate a cumulative error by initializing a counter.

Usually, a synchronous equipment requiring synchronization in a communication network may use a time synchronization signal received from a GPS satellite. That is, in the communication network, the synchronous equipment may extract an 1 Pulse-Per-Second (1PPS) signal, which is a time synchronization signal, based on the time synchronization signal received from the GPS satellite, and supply a TTL signal (or, a digital pulse signal) needed for the time synchronization to the synchronous equipment by synthesizing the TTL signal. Hereinafter, a method for controlling synchronization of an RU having divided base station functions in a communication network according to an embodiment of the present disclosure will be described in detail.

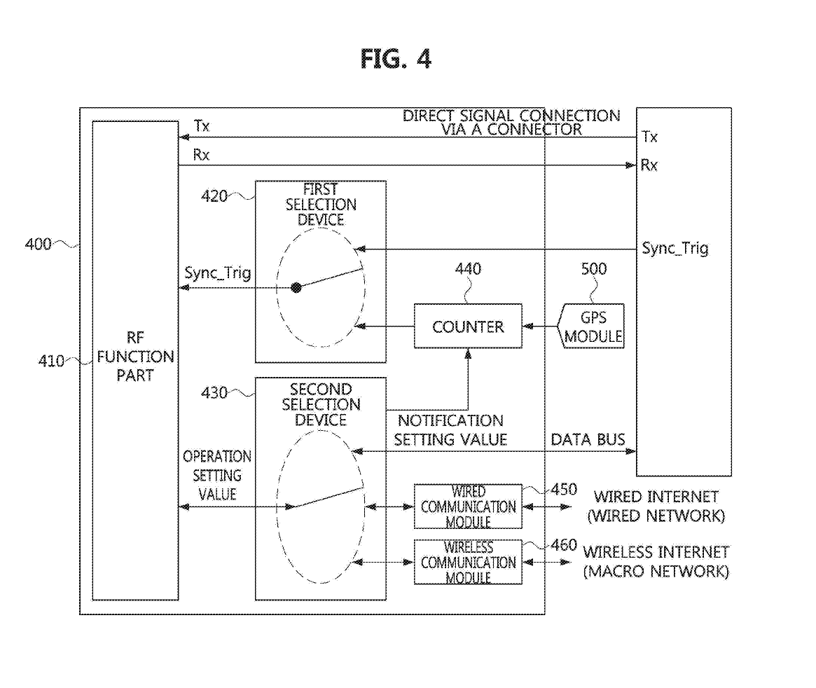

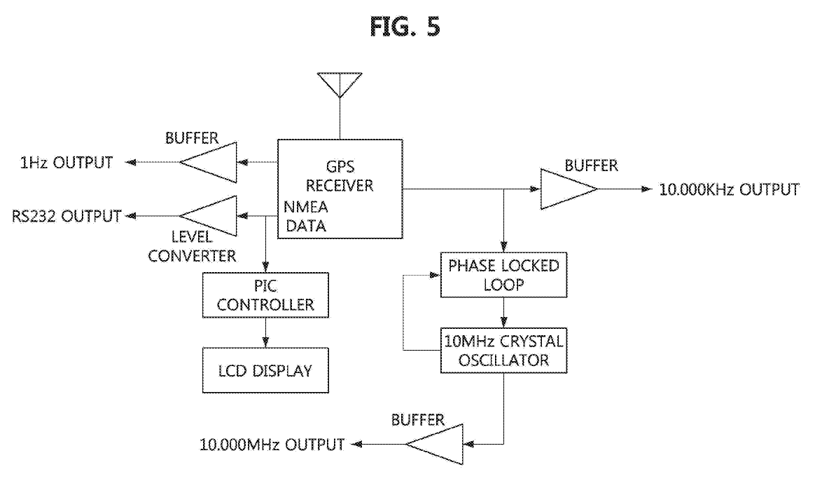

FIG. 4 is a block diagram illustrating an operation method of a communication node in a communication network according to an embodiment of the present disclosure, and FIG. 5 is a conceptual diagram illustrating a circuit used for frequency synthesis in a communication network according an embodiment of the present disclosure.

Referring to FIG. 4, a communication node 400 performing an operation method in a communication network according to an embodiment of the present disclosure may denote an RU having divided base station functions. That is, the communication node 400 may refer to the RU described with reference to FIG. 1, and may perform communications with the DU 200 which has also divided base station functions. Specifically, the communication node 400 may comprise an RF function part 410, a first selection device 420, a second selection device 430, a counter 440, a wired communication module 450, and a wireless communication module 460 in order to perform an operation method of the communication node according to an embodiment of the present disclosure.

Here, the RF function part 410 included in the communication node 400 may include an RF antenna among base station functions supported by the communication node 400, and may include an RF circuit for the RF antenna. Also, the communication node 400 may transmit a radio signal received from the DU through the RF antenna or receive a radio signal from the outside through the RF antenna. Also, the communication node 400 may switch a transmission mode of the RF antenna to transmit or receive the radio signal.

For example, the communication node 400, which is the RU having the divided base station functions, may perform communications with the DU having the divided base station functions in a time division duplexing (TDD) scheme. That is, the communication node may operate in one of an uplink transmission mode and a downlink transmission mode indicated by each of the plurality of subframes included in the frame.

Also, the first selection device 420 included in the communication node 400 may use a Sync_Trig signal of FIG. 4, which is received by being directly connected to the DU, as a TDD_Sync signal, or use a TTL signal obtained by synthesizing a digital signal with the 1 PPS signal received from the GPS module 500 as the TDD_Sync signal. Here, the notification setting value for the counter 440 may be applied to the TDD_Sync signal in connection with a predetermined target time. Through this, the communication node 400 may use a notification pulse related to the predetermined target time.

Specifically, when the TDD_Sync signal is used based on the 1PPS signal of the GPS module 500, the communication node 400 may synthesize 10 KHz or 10 MHz digital signals based on the 1PPS signal. For example, the communication node 400 may use a frequency synthesizer including a phase locked loop (PLL) and a buffer as shown in FIG. 5. That is, the communication node 400 may perform time-counting using the counter 440 from a time point at which the 1PPS signal is generated, and use a pulse signal generated every 2 ms or a pulse signal generated every 200 us. Here, the number of pulse signals may be counted in synchronization with the 1PPS signal of the GPS module, and the counter may be initialized at a starting time of the next PPS cycle. Accordingly, the communication node 400 may eliminate an accumulated error by using the counter initialized every PPS cycle.

A specific time point may be shared (or, synchronized) within a 1 second through the above-described method of generating the pulse signals. For this, a count value (i.e., ‘notification setting value’) indicating a predetermined target time in advance before the start of the cycle of the 1PPS signal. Meanwhile, in the process of generating the pulse signals, the communication node 400 may preset an ‘operation setting value’, and perform synchronization for specific functional operations based on the generated pulse signals according to the operation setting value. Also, the communication node 400 may configure in advance operation parameters other than the notification setting value, and synchronize the operation times based on the time synchronization. Here, the synchronization signal may mean transmission of a TRIG signal indicating an activation point of a ‘control data value’ needed for operation of the communication node 400.

Meanwhile, the second selection device 430 may obtain the notification setting value and the control data value (i.e., operation setting value of FIG. 4) for controlling synchronous operations through the wired communication module 450 or the wireless communication module 460. For example, the wired communication module 450 may support wired Internet (wired network) based communications like as an Internet module. Also, the wireless communication module 460 may support wireless Internet (wireless network) based communications like an LTE module. For example, when the notification setting value and the control data value are obtained via the wireless communication module 460, the notification setting value and the control data value may be obtained from a macro base station.

Then, the second selection device 430 may transfer the obtained notification setting value to the counter 440 before the TDD_Sync signal is generated. Accordingly, the counter 440 may perform the time-counting by applying the notification setting value to the 1PPS signal received from the GPS module 500. Further, the second selection device 430 may transfer the obtained operation setting value to the RF function part 410.

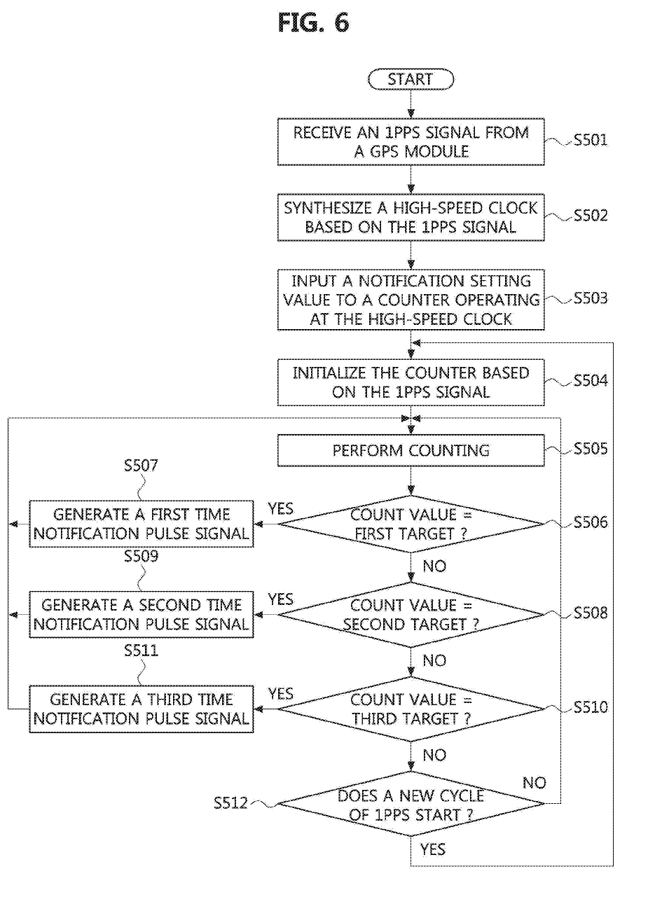

Hereinafter, an example of a specific method of generating a pulse signal for a specific time based on the notification setting value in the above-described operation method of the communication node in the communication network according to an embodiment of the present disclosure will be described with reference to FIG. 6.

FIG. 6 is a flow chart illustrating a method of generating a pulse signal in a communication network according an embodiment of the present disclosure.

Referring to FIG. 6, a communication node performing a method of generating a pulse signal in a communication network according to an embodiment of the present disclosure may refer to the communication node described with reference to FIG. 4, and may include the plurality of functional components described with reference to FIG. 4.

First, the communication node may receive an 1PPS signal from the GPS module (S501). Here, the GPS module may refer to the GPS module described with reference to FIG. 4. Then, the communication node may perform a high-speed clock synthesis based on the 1PPS signal received from the GPS module (S502). For example, the communication node may perform a synthesis of a high-speed clock of 10 MHz based on the 1PPS signal.

Then, the communication node may input a notification setting value to a counter operating at the high-speed clock (S503). Here, the notification setting value input to the counter may be obtained through the wired communication module or the wireless communication module described with reference to FIG. 4. Then, the communication node may initialize the operation of the counter at the time point when the cycle of the 1PPS signal starts (S504).

Then, the communication node may perform counting through the counter (S505). Here, the counter may generate a pulse signal when a value of the counter reaches a target corresponding to the notification setting value. Specifically, the counter may determine whether the value of the counter reaches a first target corresponding to the notification setting value (S506). Then, the counter may generate a first time notification pulse signal when the value of the counter reaches a first target corresponding to the notification setting value (S507). In this manner, when the first time notification pulse signal is generated, the communication node may perform an operation corresponding to the first time notification pulse signal and continuously perform the counting through the counter.

Additionally, the counter may determine whether the value of the counter reaches a second target corresponding to the notification setting value (S508). Then, the counter may generate a second time notification pulse signal when the value of the counter reaches a second target corresponding to the notification setting value (S509). In this manner, when the second time notification pulse signal is generated, the communication node may perform an operation corresponding to the second time notification pulse signal and continuously perform the counting through the counter.

Additionally, the counter may determine whether the value of the counter reaches a third target corresponding to the notification setting value (S510). Then, the counter may generate a third time notification pulse signal when the value of the counter reaches the third target corresponding to the notification setting value (S511). In this manner, when the third time notification pulse signal is generated, the communication node may perform an operation corresponding to the third time notification pulse signal and continuously perform the counting through the counter.

Thereafter, the communication node may determine whether a cycle of the 1PPS is newly started in the counter (S512). Here, when a cycle of the 1PP is not newly started, the communication node may continuously perform the counting count through the counter. On the other hand, when a cycle of the 1PPS is newly started, the communication node may initialize the counter of the 1PPS.

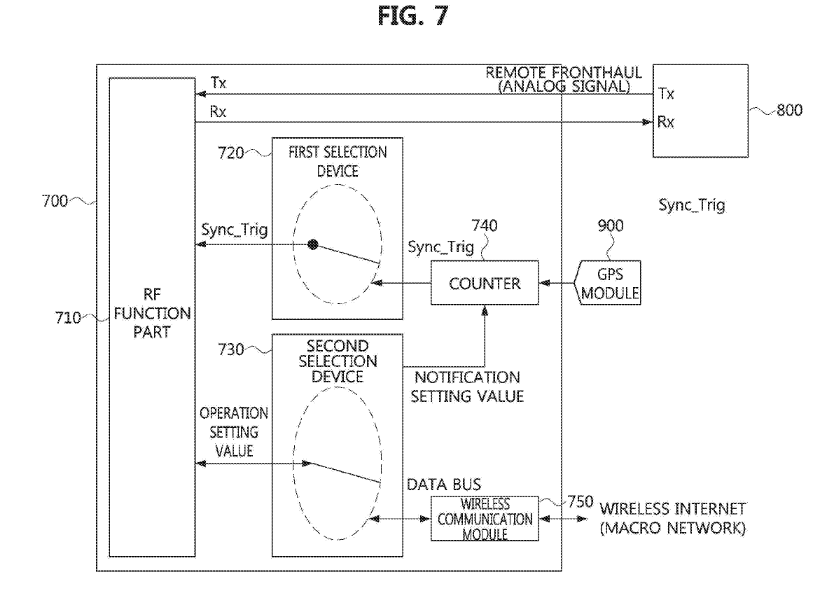

FIG. 7 is a block diagram illustrating an operation method of a communication node in a communication network according another embodiment of the present disclosure.

Referring to FIG. 7, a communication node 700 performing an operation method of a communication node in a communication network according to another embodiment of the present disclosure may be similar to the structure of the communication node described with reference to FIG. 4. Specifically, the communication node 700 may include an RF function part 710, a first selection device 720, a second selection device 730, a counter 740 and a wireless communication module 750. Basic descriptions of the plurality of functional elements included in the communication node 700 may be referred to the descriptions of the plurality of functional elements included in the communication node described with reference to FIG. 4. However, the communication network according to another embodiment of the present disclosure shown in FIG. 7 may be a case where a signal (i.e., analog signal) based on a remote fronthaul is applied.

First, the notification setting value or the control data value in the communication network according to another embodiment of the present disclosure may be used as setting values for controlling the synchronous operations. Specifically, the notification setting value or the control data value may be transmitted to a remote site via a direct signal line connection or Internet/RS485/RS422-based data communications. That is, the notification setting value or the control data value may be transmitted through the wired Internet, the wireless Internet, or the serial bus communications. Further, the notification setting value or the control data value may be set or transmitted through a radio link using another mobile communication system in addition to the methods described above.

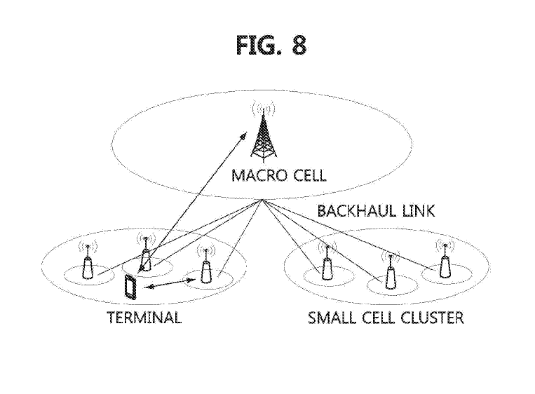

FIG. 8 is a concept diagram illustrating an example to which a method of controlling and operating synchronization according to the present disclosure is applied.

Referring to FIG. 8, a macro cell based communication network may support communications of a plurality of small cells (or cells of a microwave network of a millimeter wave band) based communication networks. For example, a plurality of small cells may form a small cell cluster, and may perform communications through a macro base station supporting a macro cell. Also, the plurality of small cells included in the small cell cluster may support communications of terminals. Also, a terminal may perform communications through the macro base station supporting the macro cell.

That is, the macro base station may manage the operations of the small cell base stations supporting the small cells. Here, there may occur a situation where an error occurs in the macro base station or the operation of the macro network becomes impossible, and a problem that the notification setting value or the control data value, which are preconfigured, cannot be transferred. In this case, a method of using a part of a utilization period for the downlink transmission to secure a downlink path of the cell site (or the small cell) base station may be applied even in a situation where the RF operation control information set value is not transmitted. Generally, since a demand for downlink transmission is larger than a demand for uplink transmission in the communication network, the downlink interval used for securing downlink paths may be variable. Here, the synchronization signal may use signals received from the GPS module (e.g., a GPS satellite) and the previously-used notification setting value.

As shown in FIG. 8, an example to which the method for controlling synchronous operations according to the present disclosure is applied may be considered. Specifically, data values required for configuration may be transferred using the wireless communication based macro network such as the LTE network, and the concept of controlling the small cell wireless communication devices using the data values may be applied.

That is, in the next generation mobile communication (e.g., 5G communication system), since the macro network can guarantee the stability and survivability of communications and the micro network takes priority in the high-speed communications, the stability of the method of controlling the micro network based on the data values transferred via the macro network can be guaranteed to a certain level or more. In this case, a method of preliminarily designing and setting basic operation values for stability of the communication system or a method of stopping cell operations may be applied to the communication network when an abnormality occurs in the operation of the macro network.

The embodiments of the present disclosure may be implemented as program instructions executable by a variety of computers and recorded on a computer readable medium. The computer readable medium may include a program instruction, a data file, a data structure, or a combination thereof. The program instructions recorded on the computer readable medium may be designed and configured specifically for the present disclosure or can be publicly known and available to those who are skilled in the field of computer software.

Examples of the computer readable medium may include a hardware device such as ROM, RAM, and flash memory, which are specifically configured to store and execute the program instructions. Examples of the program instructions include machine codes made by, for example, a compiler, as well as high-level language codes executable by a computer, using an interpreter. The above exemplary hardware device can be configured to operate as at least one software module in order to perform the embodiments of the present disclosure, and vice versa.

While the embodiments of the present disclosure and their advantages have been described in detail, it should be understood that various changes, substitutions and alterations may be made herein without departing from the scope of the present disclosure.

What is claimed is:

1. An operation method of a communication node having divided functions of a base station in a communication network, the operation method comprising:
generating digital pulse signals based on a high-speed clock synthesis for a time synchronization signal used for a synchronization operation of the communication node;
performing counting on the digital pulse signals based on a notification setting value obtained in advance for controlling the synchronization operation of the communication node;
generating a pulse signal corresponding to the notification configured value based on a result of the counting; and
performing a function of the communication node, which is divided according to supporting functions of the base station, by performing an operation indicated by the generated pulse signal.

2. The operation method according to claim 1, wherein the time synchronization signal is an 1 Pulse-Per-Second (1PPS) signal based on a global positioning system (GPS) signal obtained through a GPS module.

3. The operation method according to claim 1, wherein the communication node is a radio unit (RU) of the base station, which transmits and receives radio signals through an RF antenna.

4. The operation method according to claim 1, wherein the base station supports a time division duplexing (TDD) scheme.

5. The operation method according to claim 1, wherein the base station is a small base station supporting a small cell or a micro base station supporting a micro cell based on a millimeter-wave band.

6. The operation method according to claim 1, wherein the notification setting value is obtained in advance from a macro base station supporting a macro cell through a wireless communication module included in the communication node.

7. The operation method according to claim 1, wherein, in the generating a pulse signal, when a value of the counting reaches a first target value according to the notification setting value, a first time pulse signal according to the first target value is generated.

8. The operation method according to claim 7, wherein, in the generating a pulse signal, when the value of the counting reaches a second target value according to the notification setting value, a second time pulse signal according to the second target value is generated.

9. The operation method according to claim 1, further comprising, when a value of the counting reaches a cycle of the 1PPS signal, initializing the value of the counting.

10. The operation method according to claim 1, further comprising:
obtaining a control data value used for controlling a function performed in the communication node; and
controlling the function performed in the communication node based on the obtained control data value.

11. The operation method according to claim 10, wherein the control data value is obtained in advance from a macro base station supporting a macro cell through a wireless communication module included in the communication node.

12. A communication node having divided functions of a time division duplexing (TDD) scheme based base station in a communication network, the communication node comprising a processor and a memory storing at least one instruction executed by the processor, wherein the at least one instruction is configured to:
generate digital pulse signals based on a high-speed clock synthesis for a time synchronization signal used for a synchronization operation of the communication node;
perform counting on the digital pulse signals based on a notification setting value obtained in advance for controlling the synchronization operation of the communication node;
generate a pulse signal corresponding to the notification setting value based on a result of the counting; and
perform a function of the communication node, which is divided according to supporting functions of the base station, by performing an operation indicated by the generated pulse signal.

13. The communication node according to claim 12, wherein the time synchronization signal is an 1 Pulse-Per-Second (1PPS) signal based on a global positioning system (GPS) signal obtained through a GPS module.

14. The communication node according to claim 12, wherein the communication node is a radio unit (RU) of the base station, which transmits and receives radio signals through an RF antenna.

15. The communication node according to claim 12, wherein the notification setting value is obtained in advance from a macro base station supporting a macro cell through a wireless communication module included in the communication node.

16. The communication node according to claim 12, wherein the at least one instruction is further configured to, when a value of the counting reaches a first target value according to the notification setting value, generate a first time pulse signal according to the first target value.

17. The communication node according to claim 16, wherein the at least one instruction is further configured to, when the value of the counting reaches a second target value according to the notification setting value, generate a second time pulse signal according to the second target value.

18. The communication node according to claim 12, wherein the at least one instruction is further configured to, when a value of the counting reaches a cycle of the 1PPS signal, initialize the value of the counting.

19. The communication node according to claim 12, wherein the at least one instruction is further configured to:
obtain a control data value used for controlling a function performed in the communication node; and
control the function performed in the communication node based on the obtained control data value.

20. The communication node according to claim 19, wherein the control data value is obtained in advance from a macro base station supporting a macro cell through a wireless communication module included in the communication node.
